(19) United States
(12) Patent Application Publication
(10) Pub. No.: US 2020/0044475 A1
(43) Pub. Date: Feb. 6, 2020

(54) MULTI-RECEIVING WIRELESS CHARGING SYSTEM AND METHOD THEREOF

(71) Applicant: NEWVASTEK CO., LTD., New Taipei City (TW)

(72) Inventors: Ming Liu, New Taipei City (TW); Chengbin Ma, New Taipei City (TW); Ming-Liang Fang, New Taipei City (TW); Chih-Hao Chuang, New Taipei City (TW)

(21) Appl. No.: 16/052,580

(22) Filed: Aug. 1, 2018

(51) Int. Cl. H02J 7/02; H02J 50/40; H02J 50/12; H02J 7/00

(52) U.S. Cl. CPC H02J 7/025; H02J 50/40; H02J 2007/0059; H02J 7/0052; H02J 50/12

(57) ABSTRACT

The present invention relates to a multi-receiving wireless charging system and the method thereof. The main structure comprises: A wireless power supply component which wirelessly transmits a power signal to a plurality of receiving components, and the power signal is pass though one receiving element, one receiving compensation element, one receiving resistance element, and one rectifier element in each of the receiving components; and then the power signal is transmitted to the load element. Therefore, the chance of overheating is reduced and the charging efficiency is increased.

### (a) TECHNICAL FIELD OF THE INVENTION

The present invention relates to a multi-receiving wireless charging system and the method thereof, and especially relates to a multi-receiving wireless charging system and the method thereof which can increase the charging efficiency.

### (b) DESCRIPTION OF THE PRIOR ART

Most office workers use electronic products to discuss business matters or record things. If there is a power shortage, the consequences are mostly serious. If wanting to use them while charging, it is very easy to limit the usage space because of the charging cables. Therefore, it has already invented many wireless charging methods nowadays.

Most of the wireless charging methods use one transmitting end corresponding to one receiving end to receive power, but this kind of method uses a receiving end to charge; which may easily cause overheating at a high power, thereby affecting the efficiency during the charging.

### SUMMARY OF THE INVENTION

The main objects of the present invention is: a plurality of receiving components are used to receive the power signal given by the wireless power supply element, so as to reduce the chance of a single receiving end being prone to overheating when the power is high and to strengthen the power and efficiency of the charging at the receiving end.

To achieve the above objects, the main structure of the present invention comprises: a load element; a plurality of receiving components which connected with the load component at both ends; and a wireless power supply component which can supply power signal to each receiving component; wherein each receiving component comprises a receiving element, a receiving compensation element, a receiving resistance element, and a rectifying element; wherein the receiving element is located at one side adjacent to the wireless power supply component and the both ends of the receiving element are electrically connected with the receiving compensation element which is located at one side of the receiving element and the receiving resistance element respectively; wherein the rectifier element which is located at one side of the receiving compensation element and the receiving resistance element facing away from the receiving element and is electrically connected with the receiving compensation element, the receiving resistance element, and the load element; wherein the wireless power supply component comprises a transmitting element, a power supply element, a power supply resonant element, and a power supply resistance element; wherein the transmitting element is located at one side adjacent to the receiving components, and the both ends of the transmitting element are respectively connected with the power supply resonant element located at one side of the transmitting element and the power supply resistance element; wherein the power supply element is located at one side of the power supply resonant element and the power supply resistance element facing away from the transmitting element and which both ends are electrically connected with the power supply resonant element and the power supply resistance element respectively.

With the above structure, the power supply element in the wireless power supply component will give the power signal, and the power signal is resonantly tuned through the cooperation of the power supply resonant element and the power supply resistance element, and then the power signal is transmitted to each receiving component via the transmitting element. The receiving element in each receiving component receives the power signal, and then the rectifier element will convert the power signal into DC, and then supply to the load element.

Because the mutual inductance effect occurs between the receiving components and affects the power signal provided by the receiving component to the load component, the power signals need to be compensated by the receiving compensation element cooperated with the receiving resistance element. In this way, the result of the mutual inductance effect can be avoided.

Because the power signal is received via multiple receiving components, the power signal can be amplified to increase efficiency; and because the power received by each receiving component is smaller, it is not easy to produce the overheating phenomenon.

### BRIEF DESCRIPTION OF THE DRAWINGS

FIG. 1 is a charging schematic diagram of the preferred embodiment according to the present invention.

FIG. 2 is a mutual inductance schematic diagram of the preferred embodiment according to the present invention.

FIG. 3 is an electric current schematic diagram of the preferred embodiment according to the present invention.

FIG. 4 is the usage steps diagram of the preferred embodiment according to the present invention.

FIG. 5 is an electric circuit schematic diagram of the preferred embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

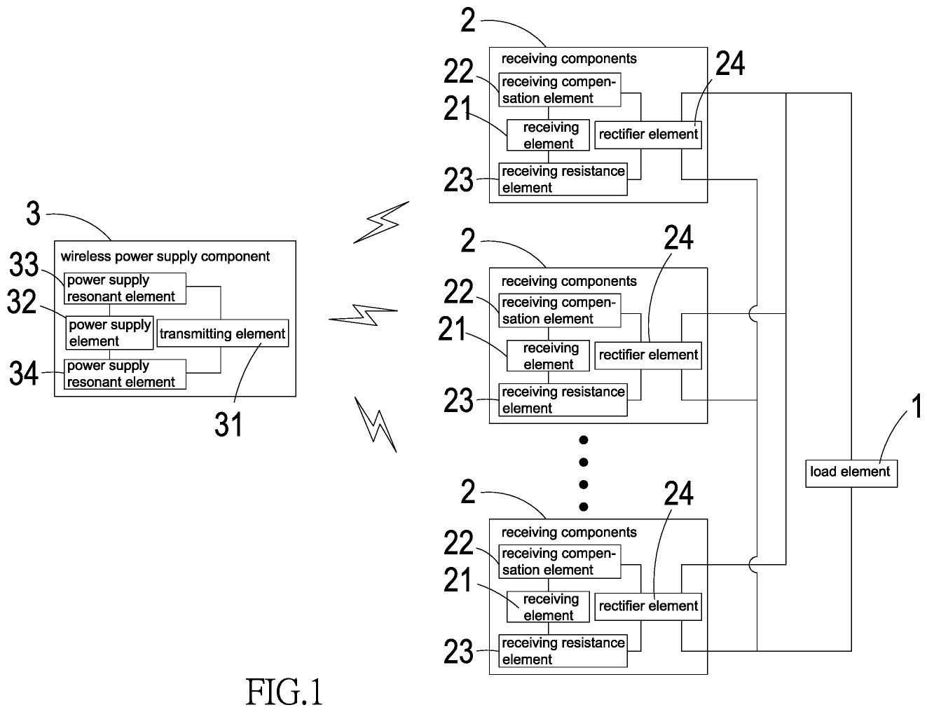

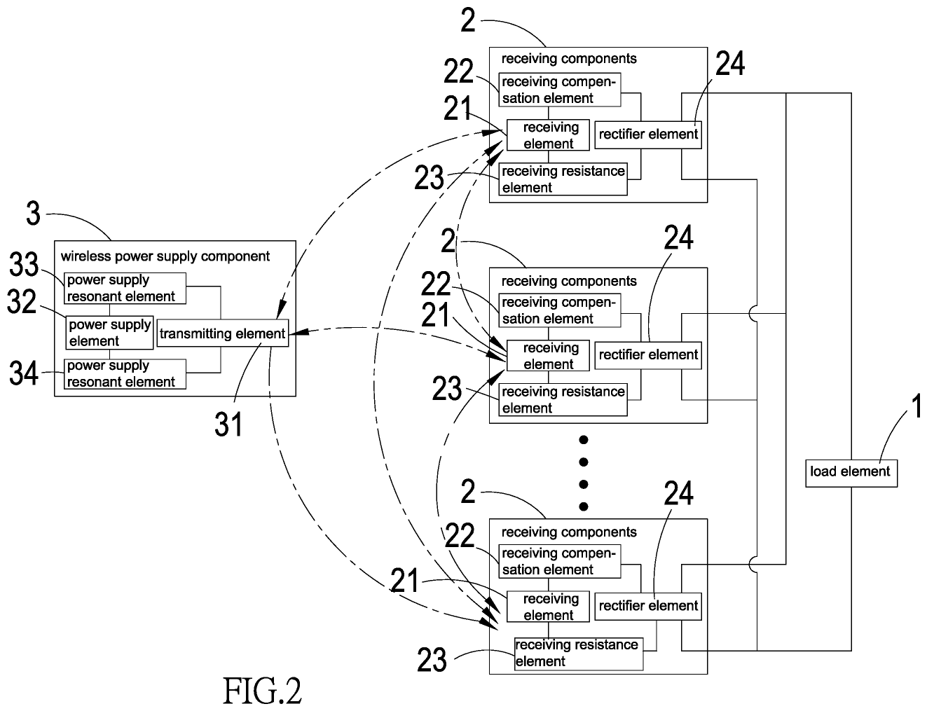

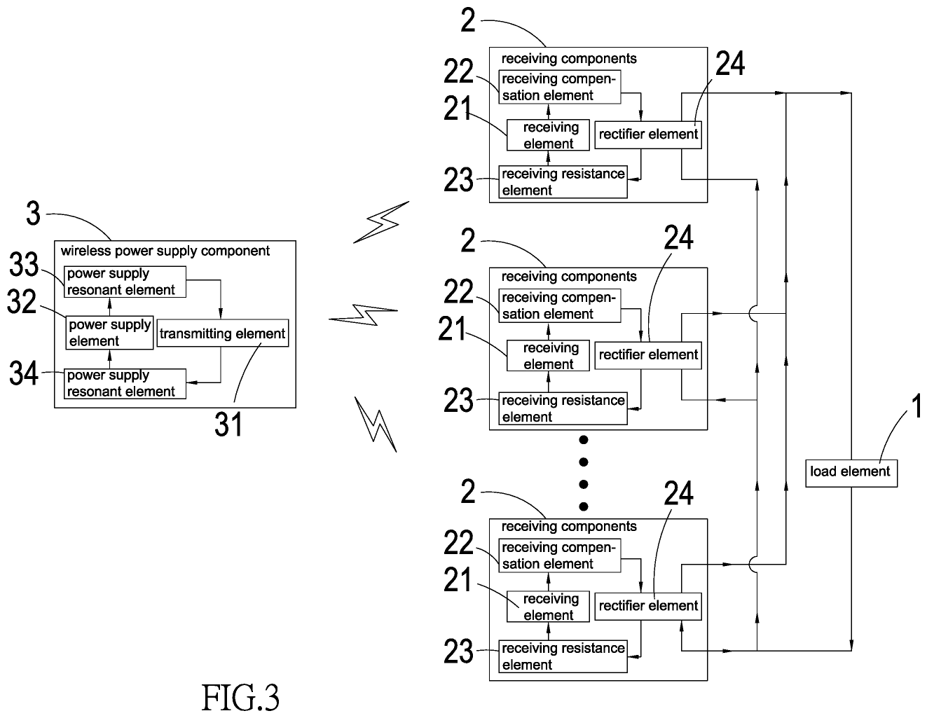

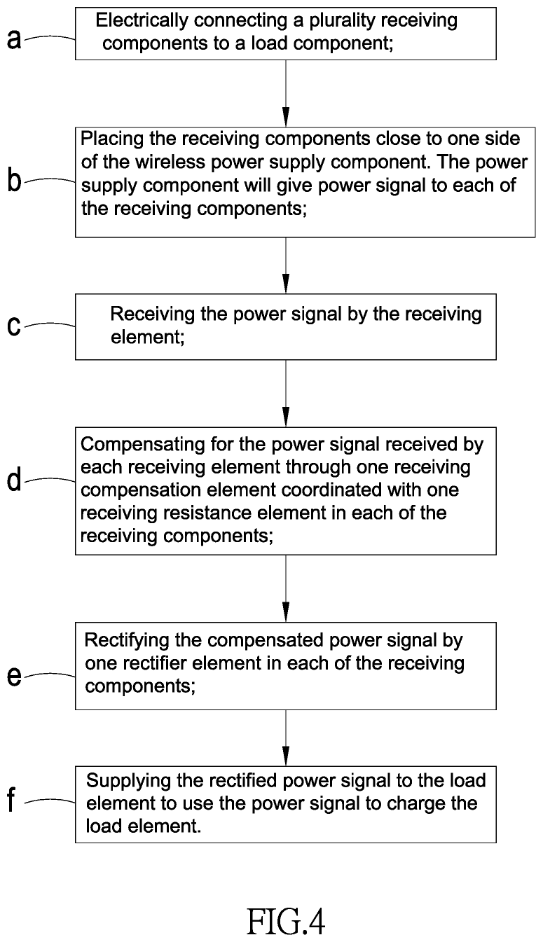

Please refer to FIG. 1 to FIG. 5: a load element 1; a plurality of receiving components 2; and a wireless power supply component 3; wherein the load component 1 is a battery in this embodiment; wherein the receiving components 2 are located at one side of the load component 1 and are electrically connected with the load component 1 at both ends; wherein the wireless power supply unit 3 which can supply power signals to the receiving components 2 is located at one side of the receiving components 2.

Each receiving component 2 comprises a receiving element 21, a receiving compensation element 22, a receiving resistance element 23, and a rectifying element 24; wherein the receiving element 21 which is a receiving antenna is located at one side adjacent to the wireless power supply component 3; wherein the receiving compensation element 22 which is a capacitor is located at one side of the receiving element 21 and is electrically connected with the receiving element 21; wherein the receiving resistance element 23 is also located at one side of the receiving element 21 and is electrically connected with the receiving element 21; wherein the rectifier element 24 which is located at one side of the receiving compensation element 22 and the receiving resistance element 23 is simultaneously electrically connected with the receiving compensation element 22, the receiving resistance element 23, and the load element 1.

The wireless power supply component 3 comprises a transmitting element 31, a power supply element 32, a power supply resonant element 33, and a power supply resistance element 34; wherein the transmitting element 31 which is a transmitting antenna is located at one side adjacent to the receiving component 2; wherein the power supply element 32 is located at one side of the transmitting element 31 and electrically connected with the transmitting element 31; wherein the power supply resonance element 33 which is a capacitor is located at one side of the transmitting element 31 and is electrically connected with the transmitting element 31; wherein the power supply resistance element 34 which is electrically connected with the transmitting element 31 is also located at one side of the transmitting element 31; wherein the power supply element 32 which two ends are respectively electrically connected with the power supply resonance element 33 and power supply resistance element 34 is located at one side of the power supply resonance element 33 and the power supply resistance element 34.

The method of the present invention is:
(a) Electrically connecting the receiving components 2 to the load component 1;
(b) Placing each of the receiving components 2 close to one side of the wireless power supply component 3. The power supply element 32 in the wireless power supply component 3 will give the power signal, and be resonantly tuned by the power supply resonant element 33 coordinated with the power supply resistance element 34, and then be transmitted by the transmitting element 31 to each receiving component 2;
(c) Receiving the power signal given from the wireless power supply component 3 by the receiving element 21 in receiving components 2;
(d) Compensating for the power signal to maintain the charging efficiency, this is because the receiving components 2 are in parallel with each other, a mutual inductance effect is generated to interfere with the charging efficiency. Therefore, it is necessary to compensate the power signal by the receiving compensation element 22 coordinated with receiving resistance element 23.
   The compensation formula is below:

$$[ \begin{matrix}{r}_{tx} & j ω {M}_{tr} & ⋯ & j ω {M}_{tr} & j ω {M}_{tr} \\ j ω {M}_{tr} & {r}_{rx} + {R}_{ec} + {L}_{rx} + {C}_{rx 1} & ⋯ & j ω {M}_{1 ( n - 1 )} & j ω {M}_{1 n} \\ ⋮ & ⋮ & ⋱ & ⋮ & ⋮ \\ j ω {M}_{tr} & j ω {M}_{1 ( n - 1 )} & ⋯ & {r}_{rx} + {R}_{rec} + {L}_{rx} + {C}_{rx ( n - 1 )} & j ω {M}_{( n - 1 ) n} \\ j ω {M}_{tr} & j ω {M}_{1 n} & ⋯ & j ω {M}_{( n - 1 ) n} & {r}_{rx} + {R}_{rec} + {L}_{rx} + {C}_{rxn}\end{matrix} ] [ \begin{matrix}{i}_{tx} \\ {i}_{rx 1} \\ ⋮ \\ {i}_{rx ( n - 1 )} \\ {i}_{rxn}\end{matrix} ] = [ \begin{matrix}{V}_{tx} \\ 0 \\ 0 \\ 0 \\ 0\end{matrix} ]$$

Through the above formula, the transmitter coil (wireless power supply component 3) is set as a pure resistance, so that the receiving coil (receiving components 2) is completely resonant, and the compensation capacitance (Crxi) of the receiving compensation element 22 can be obtained as follows:

$${C}_{rxi} = \frac{1}{{ω}^{2} ( {L}_{rx} + {\sum }_{m = 1 , m \neq i}^{n} {M}_{tm} )}$$

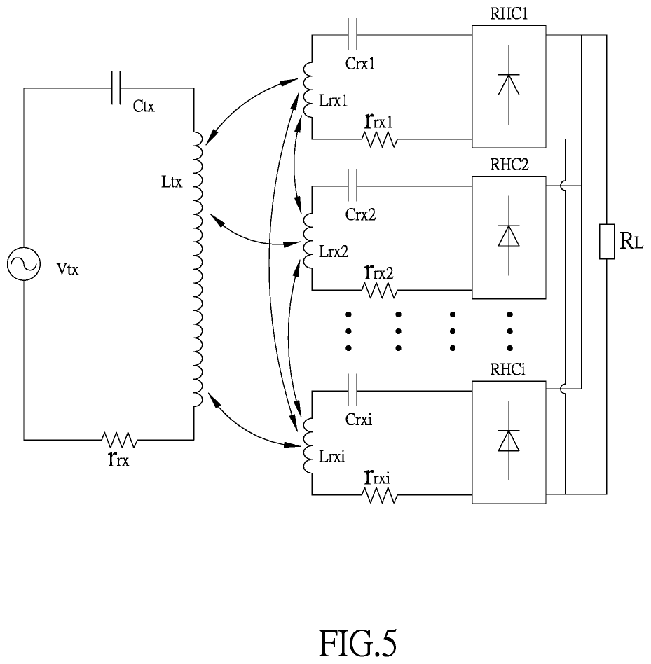

Please cooperate with FIG. 5, where:
Crxi and Crxn are the compensation capacitance of the i-th (or the n-th) receiving compensation element 22;
ω is the frequency of system work;
Lrx is the resistance of the receiving element;
rᵣₓᵢ is the i th receiving resistor element;
RECi is the i-th rectifier element;
Vtx is the power supply element;
Ctx is a power supply resonant element;
Ltx is a transmitting element;
rtx is a power supply resistor element;
RL is a load element;
R_{REC} is the resistance of the rectifier element;
Itx is the current emitted by the transmitting element;
Irxn is the current received by the nth receiving element;
Mᵢₘ is the mutual inductance between each receiving element 21 in each receiving component 2, where im is the mutual inductance between the i-th receiving element 21 and the m-th receiving element 21. For example, M₁₂ is the mutual inductance between the first receiving element 21 and the second receiving element 21.
Mₜᵣ is the mutual inductance between the wireless power supply component 3 and each receiving element 21, where r is the mutual inductance between the r-th receiving element 21 and the wireless power supply component 3, for example, Mₐ is the mutual inductance between the wireless power supply component 3 and the first receiving element 21;
Therefore, the above formula can be used to calculate the value that the receiving compensation element 22 needs to be compensated through the mutual inductance effect.
(e) The power signal after being compensated by the receiving compensation element 22 will then be converted into a DC power source via a rectifier element 24, wherein the rectifier element 24 may be one of the full-bridge rectifier, Class-D rectifier, or Class-E rectifier;
(f) The rectified power signal is added to the load element 1 to use the power signal to charge the load element 1.

Since the present invention uses multiple receiving components 2 to receive the power signals, and then transmits the power signals to a load element 1, the power signal given by the wireless power supply component 3 is a fixed value, so the signal received by each receiving component 2 is also a fixed value. But the power supply signal to the load element 1 can be continuously increased through the addition of the receiving components 2, thereby increasing the charging efficiency of the load element 1.

Since all the power signals received by each receiving component 2 is a constant values, it is not necessary to increase the power signal to be given because of the efficiency increase. Therefore, the risk of overheating of the receiving components 2 can also be reduced.

Therefore, the key to improving the conventional technology of the multi-receiving wireless charging system and the method thereof according to the present invention is: Utilizing a plurality of receiving components to increase the charging efficiency of the load element and the received power signal is still the same, so there will be no danger of overheating.

I claim:

1. A multi-receiving wireless charging system, which mainly comprises:
a load element;
a plurality of receiving components; wherein each receiving component is electrically connected with the load component at both ends and comprises a receiving element, a receiving compensation element, a receiving resistance element, and a rectifying element;
wherein the rectifier element is located at one side of the receiving compensation element and the receiving resistance element facing away from the receiving element, and both ends of the receiving compensation element are electrically connected with the receiving element and the rectifier element respectively;
wherein both ends of the receiving resistance element are also electrically connected with the receiving element and the rectifier element respectively;
wherein the rectifier element is facing away from one side of the the receiving compensation element and the rectifier element, and is electrically connected with the load element; and
a wireless power supply component located at one side of the receiving components to supply power signal to the receiving components.

2. The multi-receiving wireless charging system according to claim 1, wherein the wireless power supply component comprises a transmitting element, a power supply element, a power supply resonant element, and a power supply resistance element; wherein the transmitting element is located at one side adjacent to the receiving components; wherein the power supply resonant element and the power supply resistance element are located between the power supply element and the transmitting element; wherein both ends of the power supply resonant element are electrically connected with the power supply element and the transmitting element respectively; wherein both ends of the power supply resistance element are also electrically connected with the power supply element and the transmitting element respectively.

3. The multi-receiving wireless charging system according to claim 1, wherein the power supply resonant element is capacitance.

4. The multi-receiving wireless charging system according to claim 1, wherein the rectifier element is one of the full-bridge rectifier, Class-D rectifier, or Class-E rectifier.

5. The multi-receiving wireless charging system according to claim 1, wherein the receiving compensation element is capacitance.

6. A multi-receiving wireless charging method comprises the following steps:
(a) Electrically connecting a plurality receiving components to a load component;
(b) Placing the receiving components close to one side of the wireless power supply component. The power supply component will give power signal to each of the receiving components;
(c) Receiving the power signal by the receiving element;
(d) Compensating for the power signal received by each receiving element through one receiving compensation element coordinated with one receiving resistance element in each of the receiving components;
(e) Rectifying the compensated power signal by one rectifier element in each of the receiving components;
(f) Supplying the rectified power signal to the load element to use the power signal to charge the load element.

7. The multi-receiving wireless charging method according to claim 6, wherein the wireless power supply component in step (b) comprises a transmitting element, a power supply element, a power supply resonant element, and a power supply resistance element; wherein both ends of the power supply element are electrically connected with the power supply resonant element and the power supply resistance element; wherein the power supply resonant element and the power supply resistance element are located at one side of the power supply element and are electrically connected with the transmitting element; wherein the power supply element will emit the power signal which will be resonantly tuned by the power supply resonant element coordinated with the power supply resistance element, and then be transmitted by the transmitting element to each of the receiving components.

8. The multi-receiving wireless charging method according to claim 7, wherein the power supply resonant element is capacitance.

9. The multi-receiving wireless charging method according to claim 6, wherein the rectifier element in step (e) is one of the full-bridge rectifier, Class-D rectifier, or Class-E rectifier.

10. The multi-receiving wireless charging method according to claim 6, wherein the receiving compensation element in step (d) is capacitance.
